(19) United States
(12) Patent Application Publication
(10) Pub. No.: US 2021/0280871 A1
(43) Pub. Date: Sep. 9, 2021

(54) Conducting Polymer Network-Protected Nanowires of an Anode Active Material for Lithium-Ion Batteries

(71) Applicant: Global Graphene Group, Inc., Dayton, OH (US)

(72) Inventor: Bor Z. Jang, Centerville, OH (US)

(73) Assignee: Global Graphene Group, Inc., Dayton, OH (US)

(21) Appl. No.: 16/810,163

(22) Filed: Mar. 5, 2020

(51) Int. Cl. H01M 4/60; H01M 10/0525; H01M 4/38; H01M 10/0565; H01M 4/04; H01M 4/583

(52) U.S. Cl. CPC H01M 4/604; H01M 10/0525; H01M 4/583; H01M 10/0565; H01M 4/0466; H01M 4/386

(57) ABSTRACT

Provided is a composite particulate for use in a lithium-ion battery anode. The composite particulate comprises one or a plurality of nanowires of an anode active material (e.g. Si, Ge, Sn, SiOₓ, SnO₂, etc., where 0.1≤x≤1.9), having a diameter or thickness from 0.5 nm to 500 nm, encapsulated by or embedded in an electrically and/or ionically conducting polymer gel network. The polymer gel network may further comprise graphene sheets and/or other conductive additives (e.g. carbon nanotubes, CNT) dispersed therein. Also provided is a process for producing multiple composite particulates herein described.

### FIELD

The present disclosure relates generally to the field of lithium-ion batteries and, in particular, to composite particulates comprising conducting polymer network-embraced nanowires of an anode active material for lithium-ion batteries.

### BACKGROUND

A unit cell or building block of a lithium-ion battery is typically composed of an anode current collector, an anode or negative electrode layer (containing an anode active material responsible for storing lithium therein, a conductive additive, and a resin binder), an electrolyte and porous separator, a cathode or positive electrode layer (containing a cathode active material responsible for storing lithium therein, a conductive additive, and a resin binder), and a separate cathode current collector. The electrolyte is in ionic contact with both the anode active material and the cathode active material. A porous separator is not required if the electrolyte is a solid-state electrolyte.

The binder in the binder layer is used to bond the anode active material (e.g. graphite or Si particles) and a conductive filler (e.g. carbon black or carbon nanotube) together to form an anode layer of structural integrity, and to bond the anode layer to a separate anode current collector, which acts to collect electrons from the anode active material when the battery is discharged. In other words, in the negative electrode (anode) side of the battery, there are typically four different materials involved: an anode active material, a conductive additive, a resin binder (e.g. polyvinylidene fluoride, PVDF, or styrene-butadiene rubber, SBR), and an anode current collector (typically a sheet of Cu foil). Typically the former three materials form a separate, discrete anode layer and the latter one forms another discrete layer.

The most commonly used anode active materials for lithium-ion batteries are natural graphite and synthetic graphite (or artificial graphite) that can be intercalated with lithium and the resulting graphite intercalation compound may be expressed as LiₓC₆, where x is typically less than 1. The maximum amount of lithium that can be reversibly intercalated into the interstices between graphene planes of a perfect graphite crystal corresponds to x=1, defining a theoretical specific capacity of 372 mAh/g.

Graphite or carbon anodes can have a long cycle life due to the presence of a protective solid-electrolyte interface layer (SEI), which results from the reaction between lithium and the electrolyte (or between lithium and the anode surface/edge atoms or functional groups) during the first several charge-discharge cycles. The lithium in this reaction comes from some of the lithium ions originally intended for the purpose of the charge transfer between an anode and a cathode. As the SEI is formed, the lithium ions become part of the inert SEI layer and become irreversible, i.e. these positive ions can no longer be shuttled back and forth between the anode and the cathode during subsequent charges/discharges. Therefore, it is desirable to use a minimum amount of lithium for the formation of an effective SEI layer. In addition to SEI formation, the irreversible capacity loss Qᵢᵣ can also be attributed to graphite exfoliation caused by electrolyte/solvent co-intercalation and other side reactions.

In addition to carbon- or graphite-based anode materials, other inorganic materials that have been evaluated for potential anode applications include metal oxides, metal nitrides, metal sulfides, and the like, and a range of metals, metal alloys, and intermetallic compounds that can accommodate lithium atoms/ions or react with lithium. Among these materials, lithium alloys having a composition formula of LiₐA (A is a metal or semiconductor element, such as Al and Si, and “a” satisfies 0<a≤5) are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.

To overcome the problems associated with such mechanical degradation, three technical approaches have been proposed:
(1) reducing the size of the active material particle, presumably for the purpose of reducing the total strain energy that can be stored in a particle, which is a driving force for crack formation in the particle. However, a reduced particle size implies a higher surface area available for potentially reacting with the liquid electrolyte to form a higher amount of SEI. Such a reaction is undesirable since it is a source of irreversible capacity loss.
(2) depositing the electrode active material in a thin film form directly onto a current collector, such as a copper foil. However, such a thin film structure with an extremely small thickness-direction dimension (typically much smaller than 500 nm, often necessarily thinner than 100 nm) implies that only a small amount of active material can be incorporated in an electrode (given the same electrode or current collector surface area), providing a low total lithium storage capacity and low lithium storage capacity per unit electrode surface area (even though the capacity per unit mass can be large). Such a thin film must have a thickness less than 100 nm to be more resistant to cycling-induced cracking, further diminishing the total lithium storage capacity and the lithium storage capacity per unit electrode surface area. Such a thin-film battery has very limited scope of application. A desirable and typical electrode thickness is from 100 μm to 200 μm. These thin-film electrodes (with a thickness of <500 nm or even <100 nm) fall short of the required thickness by three (3) orders of magnitude, not just by a factor of 3.
(3) using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nanoparticles. Presumably, the protective matrix provides a cushioning effect for particle expansion or shrinkage, and prevents the electrolyte from contacting and reacting with the electrode active material. Examples of high-capacity anode active particles are Si, Sn, and SnO₂. Unfortunately, when an active material particle, such as Si particle, expands (e.g. up to a volume expansion of 380%) during the battery charge step, the protective coating is easily broken due to the mechanical weakness and/o brittleness of the protective coating materials. There has been no high-strength and high-toughness material available that is itself also lithium ion conductive.

It may be further noted that the coating or matrix materials used to protect active particles (such as Si and Sn) are carbon, sol gel graphite, metal oxide, monomer, ceramic, and lithium oxide. These protective materials are all very brittle, weak (of low strength), and/or non-conductive to lithium ions (e.g., ceramic or oxide coating). Ideally, the protective material should meet the following requirements: (a) The protective material must be lithium ion-conducting as well as initially electron-conducting (when the anode electrode is made) and be capable of preventing liquid electrolyte from being in constant contact with the anode active material particles (e.g. Si). (b) The protective material should also have high fracture toughness or high resistance to crack formation to avoid disintegration during cycling. (c) The protective material must be inert (inactive) with respect to the electrolyte, but be a good lithium ion conductor. (d) The protective material must not provide any significant amount of defect sites that irreversibly trap lithium ions. (e) The combined protective material-anode material structure must allow for an adequate amount of free space to accommodate volume expansion of the anode active material particles when lithiated. The prior art protective materials all fall short of these requirements. Hence, it is not surprising to observe that the resulting anode typically shows a reversible specific capacity much lower than expected. In many cases, the first-cycle efficiency is extremely low (mostly lower than 80% and some even lower than 60%). Furthermore, in most cases, the electrode was not capable of operating for a large number of cycles. Additionally, most of these electrodes are not high-rate capable, exhibiting unacceptably low capacity at a high discharge rate.

Due to these and other reasons, most of prior art composite electrodes and electrode active materials have deficiencies in some ways, e.g., in most cases, less than satisfactory reversible capacity, poor cycling stability, high irreversible capacity, ineffectiveness in reducing the internal stress or strain during the lithium ion insertion and extraction steps, and other undesirable side effects.

Complex composite particles of particular interest are a mixture of separate Si and graphite particles dispersed in a carbon matrix; e.g. those prepared by Mao, et al. [“Carbon-coated Silicon Particle Powder as the Anode Material for Lithium Batteries and the Method of Making the Same,” US 2005/0136330 (Jun. 23, 2005)]. Also of interest are carbon matrix-containing complex nano Si (protected by oxide) and graphite particles dispersed therein, and carbon-coated Si particles distributed on a surface of graphite particles Again, these complex composite particles led to a low specific capacity or for up to a small number of cycles only. It appears that carbon by itself is relatively weak and brittle and the presence of micron-sized graphite particles does not improve the mechanical integrity of carbon since graphite particles are themselves relatively weak. Graphite was used in these cases presumably for the purpose of improving the electrical conductivity of the anode material. Furthermore, polymeric carbon, amorphous carbon, or pre-graphitic carbon may have too many lithium-trapping sites that irreversibly capture lithium during the first few cycles, resulting in excessive irreversibility.

In summary, the prior art has not demonstrated a material that has all or most of the properties desired for use as an anode active material in a lithium-ion battery. Thus, there is an urgent and continuing need for a new anode active material that enables a lithium-ion battery to exhibit a high cycle life, high reversible capacity, low irreversible capacity, small particle sizes (for high-rate capacity), and compatibility with commonly used electrolytes. There is also a need for a process for readily or easily producing such a material in large quantities.

Thus, it is a specific object of the present disclosure to meet these needs and address the issues associated the rapid capacity decay of a lithium battery containing a high-capacity anode active material.

### SUMMARY

The present disclosure provides a composite particulate or multiple composite particulates for use in a lithium-ion battery anode, wherein the composite particulate comprises one or a plurality of nanowires of an anode active material, having a diameter or thickness from 0.5 nm to 500 nm, encapsulated by or embedded in an electrically and/or ionically conducting polymer gel network.

In certain embodiments, the composite particulate further comprises graphene sheets that are embedded or dispersed in the conducting polymer gel network. However, the external surfaces of the composite particulate do not contain graphene sheets that encapsulate the nanowire-conducting polymer network core.

Preferably, the electrically conducting polymer gel network contains a conjugated polymer selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, a sulfonated version thereof, or a combination thereof.

In some preferred embodiments, the conducting polymer gel network comprises a polyaniline hydrogel, polypyrrole hydrogel, or polythiophene hydrogel in a dehydrated state. Such a conducting polymer gel network is typically a lightly crosslinked polymer.

In some embodiments, the ionically conducting polymer gel network comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

In certain alternative embodiments, the disclosure provides multiple composite particulates for a lithium battery, at least one of the composite particulates comprising one or a plurality of nanowires of an anode active material and graphene sheets that are embedded in, dispersed in, or encapsulated by a conducting polymer gel network. However, preferably, the exterior surface of the composite particulate does not contain graphene sheets. The dispersed or embedded graphene sheets are selected from pristine graphene, graphene oxide (GO), reduced graphene oxide (RGO), graphene fluoride, graphene chloride, graphene bromide, graphene iodide, nitrogenated graphene, hydrogenated graphene, doped graphene, chemically functionalized graphene, or a combination thereof.

In some embodiments, the conducting polymer gel network is reinforced with a high-strength material selected from carbon nanotubes, carbon nano-fibers, carbon or graphite fibers, graphene sheets, expanded graphite flakes, polymer fibrils, glass fibers, ceramic fibers, metal filaments or metal nanowires, whiskers, or a combination thereof.

In some embodiments, the anode active material in the composite particulate is selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) oxides of Si, Ge, Sn, Pb, Sb, Bi, Zn, Al, Ti, Fe, Ni, Co, V, and Cd; (c) prelithiated versions thereof; and (d) combinations thereof.

In some preferred embodiments, the anode active material nanowires contain a prelithiated Si, prelithiated Ge, prelithiated Sn, prelithiated SnOₓ, prelithiated SiO_{y}, or a combination thereof, wherein 0.1≤x≤2 and 0.1≤y≤1.9.

Preferably, at least one of the nanowires in the composite particulate is coated with a layer of carbon, graphite, or graphene.

In some embodiments, the composite particulate further comprises from 0.1% to 40% by weight of a lithium ion-conducting additive dispersed in the electrically or ionically conducting polymer gel network.

In certain embodiments, the particulate further comprises from 0.1% to 40% by weight of a lithium ion-conducting additive dispersed in the conducting polymer gel network. The lithium ion-conducting additive may be selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0≤x≤1, 1≤y≤4. Alternatively, the lithium ion-conducting additive contains a lithium salt selected from lithium perchlorate (LiClO₄), lithium hexafluorophosphate (LiPF₆), lithium borofluoride (LiBF₄), lithium hexafluoroarsenide (LiAsF₆), lithium trifluoro-methanesulfonate (LiCF₃SO₃), bis-trifluoromethyl sulfonylimide lithium (LiN(CF₃ SO₂)₂), lithium bis(oxalato)borate (LiBOB), lithium oxalyldifluoroborate (LiBF₂C₂O₄), lithium nitrate (LiNO₃), Li-fluoroalkyl-phosphate (LiPF₃(CF₂CF₃)₃), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

The electrically or ionically conducting polymer gel network may further contain graphene sheets dispersed or embedded therein. The multiple graphene sheets in the embedding matrix of conducting polymer gel network may comprise single-layer or few-layer graphene, wherein said few-layer graphene sheets have 2-10 layers of stacked graphene planes having an inter-plane spacing d₀₀₂ from 0.3354 nm to 0.6 nm as measured by X-ray diffraction and said single-layer or few-layer graphene sheets contain a pristine graphene material having essentially zero % of non-carbon elements, or a non-pristine graphene material having 0.001% to 25% by weight of non-carbon elements. The non-pristine graphene is selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

In certain embodiments, at least one of the anode active material particles is coated with a layer of carbon or graphene prior to being dispersed in the conducting polymer gel network.

In some embodiments, the nanowires of anode active material contain pre-lithiated nanowires. In other words, before the electrode active material nanowires (such as Si, SiOₓ, or SnO₂) are dispersed in the conducting polymer gel network or its precursor (monomer or oligomer, etc.), these nanowires have been previously intercalated with Li ions (e.g. via electrochemical charging) up to an amount of typically 0.1% to 30% by weight of Li.

In some embodiments, the nanowires of anode active material are pre-coated with a coating layer of a conductive material selected from carbon, pitch, carbonized resin, a conductive polymer, a conductive organic material, a metal coating, a metal oxide shell, graphene sheets, or a combination thereof. The coating layer thickness is preferably in the range from 1 nm to 20 μm, preferably from 5 nm to 10 μm, and further preferably from 10 nm to 1 μm.

The present disclosure also provides a powder mass of graphene-embraced anode particulates produced by the aforementioned method, wherein the graphene proportion is from 0.01% to 20% by weight based on the total particulate weight.

The disclosure also provides a powder mass comprising presently disclosed composite particulates and a battery anode comprising this powder mass. Also provided is a battery containing the battery anode.

There are several well-known methods of producing semiconductor or metal nanowires. The presently disclosed composite particulates can contain the nanowires produced by any available means.

A preferred process for initiating and growing semiconductor or metal nanowires from corresponding micron or sub-micron scaled semiconductor or metal particles having an original particle diameter (prior to nanowire growth) from 50 nm to 500 μm (preferably from 100 nm to 20 μm) is herein briefly discussed. The starting material is micron or sub-micron scaled semiconductor or metal particles, which are thermally and catalytically converted directly into nano-scaled, wire-shaped structures having a diameter or thickness from 2 nm to 100 nm. The process comprises: (A) preparing a source metal or semiconductor material in a solid particulate form (e.g. multiple particles of the source metal or semiconductor such as Sn and Si) having a size from 50 nm to 500 μm; (B) depositing a catalytic metal, in the form of nanoparticles having a size from 1 nm to 100 nm or a nano-coating having a thickness from 1 nm to 100 nm, onto a surface or surfaces of the source metal or semiconductor particulate to form a catalyst metal-coated metal or semiconductor particles, wherein the catalytic metal is different than the source metal material; and (C) exposing the catalyst metal-coated particles to a high temperature environment, from 100° C. to 2,500° C., for a period of time sufficient to enable a catalytic metal-assisted growth of multiple metal or semiconductor nanowires from the source metal particulate. Several examples are presented in a later section of the present disclosure.

The present disclosure also provides a process for producing multiple composite particulates of conducting polymer gel network-protected nanowires of an anode active material for a lithium-ion battery. In certain embodiments, the process comprises (A) dispersing multiple nanowires of the desired anode active material in a reacting mass comprising a monomer (along with an initiator or catalyst, a curing or cross-linking agent, etc.) or an oligomer (low molecular weight, growing chains) to form a reacting slurry (suspension, dispersion, etc.); (B) forming the reacting slurry into multiple reacting droplets, wherein the droplet comprises one or a plurality of nanowires dispersed in a matrix of polymerizing or cross-linking chains; and (C) converting the polymerizing or cross-linking chains into a network polymer in the droplets to form the composite particulates of polymer gel network-protected nanowires. Steps (B) and (C) may be conducted concurrently or sequentially.

Step (B) of forming reacting droplets may be accomplished by operating a procedure selected from pan-coating, air-suspension coating, centrifugal extrusion, vibration-nozzle encapsulation, spray-drying, coacervation-phase separation, interfacial polycondensation or interfacial cross-linking, in-situ polymerization, matrix polymerization, or a combination thereof.

In some embodiments, the reacting mass used in step (A) may contain a monomer, an initiator or catalyst, a crosslinking or gelating agent, an oxidizer and/or a dopant. Before, during or after the droplet formation procedure, one may initiate the polymerization and crosslinking reactions to produce lightly cross-linked networks of conducting polymer chains inside the droplets and on the droplet surfaces. These networks of polymer chains, if impregnated with water or an organic liquid solvent, can become a gel. In composite the particulate, the nanowires, along with optional graphene sheets and other conductive additives (e.g. CNTs), are embedded in, dispersed in, or encapsulated by the conducting polymer network gel.

### BRIEF DESCRIPTION OF THE DRAWINGS

FIG. 1 A flow chart showing the most commonly used prior art process for producing highly oxidized graphene sheets (or nano graphene platelets, NGPs) that entails chemical oxidation/intercalation, rinsing, and exfoliation procedures.

FIG. 2(A) Schematic illustrating the notion that expansion of Si particles, upon lithium intercalation during charging of a prior art lithium-ion battery, can lead to pulverization of Si particles, interruption of the conductive paths formed by the conductive additive, and loss of contact with the current collector;

FIG. 2(B) illustrates the issues associated with prior art anode active material; for instance, a non-lithiated Si particle encapsulated by a protective shell (e.g. carbon shell) in a core-shell structure inevitably leads to breakage of the shell and that a pre-lithiated Si particle encapsulated with a protective layer leads to poor contact between the contracted Si particle and the rigid protective shell during battery discharge.

FIG. 3 Process flow chart for producing composite particulates comprising conductive polymer network-protected nanowires.

FIG. 4 SEM image of Si nanowires

FIG. 5 SEM image of Ge nanowires.

FIG. 6 SEM image of Sn nanowires.

FIG. 7 The cycling behaviors of two lithium-ion cells: one a composite featuring an anode containing polypyrrole network polymer-encapsulated Sn nanowires as the anode active material and the other amorphous carbon-encapsulated Sn nanowires as the anode active material.

### DETAILED DESCRIPTION OF PREFERRED EMBODIMENTS

A lithium-ion battery cell is typically composed of an anode current collector (e.g. Cu foil), an anode or negative electrode active material layer (i.e. anode layer typically containing particles of an anode active material, conductive additive, and binder), a porous separator and/or an electrolyte component, a cathode or positive electrode active material layer (containing a cathode active material, conductive additive, and resin binder), and a cathode current collector (e.g. Al foil). More specifically, the anode layer is composed of particles of an anode active material (e.g. graphite, Sn, SnO₂, or Si), a conductive additive (e.g. carbon black particles), and a resin binder (e.g. SBR or PVDF). This anode layer is typically 50-300 μm thick (more typically 100-200 μm) to give rise to a sufficient amount of current per unit electrode area.

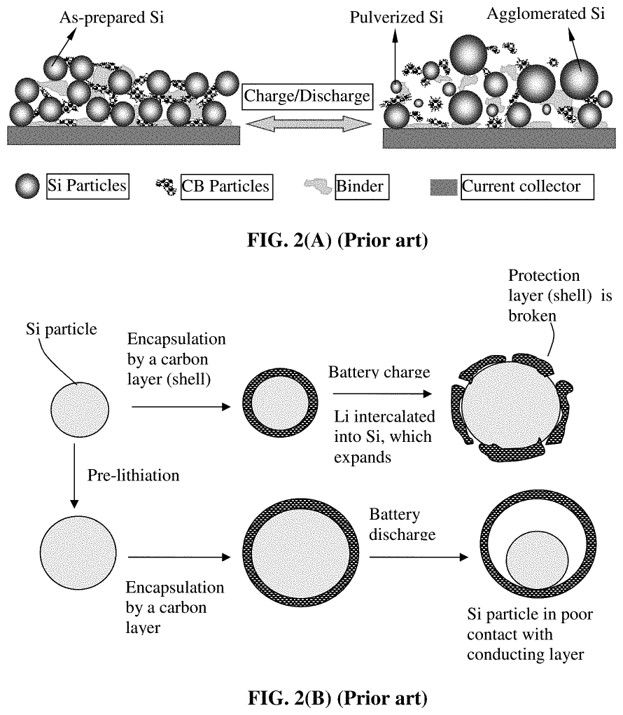

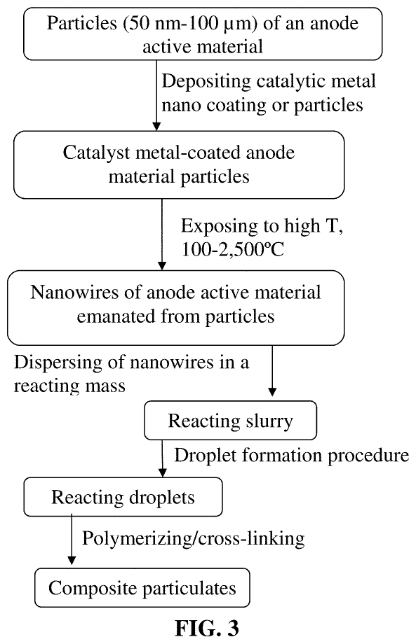

In order to obtain a higher energy density cell, the anode can be designed to contain higher-capacity anode active materials having a composition formula of LiₐA (A is a metal or semiconductor element, such as Al and Si, and “a” satisfies 0<a≤5). These materials are of great interest due to their high theoretical capacity, e.g., Li₄Si (3,829 mAh/g), Li_{4.4}Si (4,200 mAh/g), Li_{4.4}Ge (1,623 mAh/g), Li_{4.4}Sn (993 mAh/g), Li₃Cd (715 mAh/g), Li₃Sb (660 mAh/g), Li_{4.4}Pb (569 mAh/g), LiZn (410 mAh/g), and Li₃Bi (385 mAh/g). However, as discussed in the Background section, there are several problems associated with the implementation of these high-capacity anode active materials:
1) As schematically illustrated in FIG. 2(A), in an anode composed of these high-capacity materials, severe pulverization (fragmentation of the alloy particles) occurs during the charge and discharge cycles due to severe expansion and contraction of the anode active material particles induced by the insertion and extraction of the lithium ions in and out of these particles. The expansion and contraction, and the resulting pulverization, of active material particles, lead to loss of contacts between active material particles and conductive additives and loss of contacts between the anode active material and its current collector. These adverse effects result in a significantly shortened charge-discharge cycle life.
2) The approach of using a composite composed of small electrode active particles protected by (dispersed in or encapsulated by) a less active or non-active matrix, e.g., carbon-coated Si particles, sol gel graphite-protected Si, metal oxide-coated Si or Sn, and monomer-coated Sn nanoparticles, has failed to overcome the capacity decay problem. Presumably, the protective matrix provides a cushioning effect for particle expansion or shrinkage, and prevents the electrolyte from contacting and reacting with the electrode active material. Unfortunately, when an active material particle, such as Si particle, expands (e.g. up to a volume expansion of 380%) during the battery charge step, the protective coating is easily broken due to the mechanical weakness and/or brittleness of the protective coating materials. There has been no high-strength and high-toughness material available that is itself also lithium ion conductive.
3) The approach of using a core-shell structure (e.g. Si nanoparticle encapsulated in a carbon or SiO₂ shell) also has not solved the capacity decay issue. As illustrated in upper portion of FIG. 2(B), a non-lithiated Si particle can be encapsulated by a carbon shell to form a core-shell structure (Si core and carbon or SiO₂ shell in this example). As the lithium-ion battery is charged, the anode active material (carbon- or SiO₂-encapsulated Si particle) is intercalated with lithium ions and, hence, the Si particle expands. Due to the brittleness of the encapsulating shell (carbon), the shell is broken into segments, exposing the underlying Si to electrolyte and subjecting the Si to undesirable reactions with electrolyte during repeated charges/discharges of the battery. These reactions continue to consume the electrolyte and reduce the cell's ability to store lithium ions.
4) Referring to the lower portion of FIG. 2(B), wherein the Si particle has been pre-lithiated with lithium ions; i.e. has been pre-expanded in volume. When a layer of carbon (as an example of a protective material) is encapsulated around the pre-lithiated Si particle, another core-shell structure is formed. However, when the battery is discharged and lithium ions are released (de-intercalated) from the Si particle, the Si particle contracts, leaving behind a large gap between the protective shell and the Si particle. Such a configuration is not conducive to lithium intercalation of the Si particle during the subsequent battery charge cycle due to the gap and the poor contact of Si particle with the protective shell (through which lithium ions can diffuse). This would significantly curtail the lithium storage capacity of the Si particle particularly under high charge rate conditions.

In other words, there are several conflicting factors that must be considered concurrently when it comes to the design and selection of an anode active material in terms of material type, shape, size, porosity, and electrode layer thickness. Thus far, there has been no effective solution offered by any prior art teaching to these conflicting problems. We have solved these challenging issues that have troubled battery designers and electrochemists alike for more than 30 years by developing the composite particulates of conducting polymer gel network-protected nanowires of an anode active material (e.g. Si and SiOₓ particles, 0.1<x<1.9).

The disclosure provides a composite particulate or multiple composite particulates for use in a lithium-ion battery anode, wherein the composite particulate comprises one or a plurality of nanowires of an anode active material, having a diameter or thickness from 0.5 nm to 500 nm, encapsulated by or embedded in an electrically and/or ionically conducting polymer gel network.

Preferably, the electrically conducting polymer gel network contains a conjugated polymer selected from Polyacetylene, Polythiophene, Poly(3-alkylthiophenes), Polypyrrole, Polyaniline, Poly(isothianaphthene), Poly(3,4-ethylenedioxythiophene) (PEDOT), alkoxy-substituted Poly(p-phenylene vinylene), Poly(2,5-bis(cholestanoxy) phenylene vinylene), Poly(p-phenylene vinylene), Poly(2,5-dialkoxy) paraphenylene vinylene, Poly[(1,4-phenylene-1,2-diphenylvinylene)], Poly(3′,7′-dimethyloctyloxy phenylene vinylene), Polyparaphenylene, Polyparaphenylene, Polyparaphenylene sulphide, Polyheptadiyne, Poly(3-hexylthiophene), Poly(3-octylthiophene), Poly(3-cyclohexylthiophene), Poly(3-methyl-4-cyclohexylthiophene), Poly(2,5-dialkoxy-1,4-phenyleneethynylene), Poly(2-decyloxy-1,4-phenylene), Poly(9,9-dioctylfluorene), Polyquinoline, a derivative thereof, a copolymer thereof, a sulfonated version thereof, or a combination thereof.

Further preferably, the conducting polymer gel network comprises a polyaniline network, polypyrrole network, or polythiophene network. Such a conducting polymer network is typically a lightly crosslinked polymer, capable of elastically deforming to a significant extent (typically at least >10% and can be higher than 50% under tension). Elastic deformation means that the deformation is reversible.

The ionically conducting polymer gel network preferably comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

The anode active material in the composite particulate is preferably selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) oxides of Si, Ge, Sn, Pb, Sb, Bi, Zn, Al, Ti, Fe, Ni, Co, V, and Cd; (c) prelithiated versions thereof; and (d) combinations thereof. Among these, nanowires of Si, Ge, Sn, SnO₂ and SiO_{y} (0.1≤y≤1.9) are most desired. Most preferably, the anode active material nanowires contain a prelithiated Si, prelithiated Ge, prelithiated Sn, prelithiated SnOₓ, prelithiated SiO_{y}, or a combination thereof, wherein 0.1≤x≤2 and 0.1≤y≤1.9.

The anode active material is in a form of free-standing nanowires having a diameter or thickness from 0.5 nm to 500 nm (preferably from 1 nm to 100 nm). One or a plurality of nanowires are embedded in, dispersed in, or encapsulated by a conducting polymer gel network to form a micro-droplet, preferably having a diameter from 100 nm to 100 μm (preferably and more typically from 0.5 μm to 50 μm and most preferably from 1 μm to 10 μm).

There are several well-known methods of producing nanowires of a semiconductor (e.g. Si and Ge) or metal (e.g. Sn, Zn, and Al). Oxide-based nanowires may be produced from oxidation of semiconductor or metal nanowires. The presently disclosed composite particulates can contain the nanowires produced by any available means.

A preferred process for growing semiconductor or metal nanowires from corresponding micron or sub-micron scaled semiconductor or metal particles having an original particle diameter (prior to nanowire growth) from 50 nm to 500 μm (preferably from 100 nm to 20 μm) is herein briefly discussed. The starting material is micron or sub-micron scaled semiconductor or metal particles, which are thermally and catalytically converted directly into nano-scaled, wire-shaped structures having a diameter or thickness from 2 nm to 100 nm. The process comprises: (A) preparing a source metal or semiconductor material in a solid particulate form (e.g. multiple particles of the source metal or semiconductor such as Sn and Si) having a size from 50 nm to 500 μm; (B) depositing a catalytic metal, in the form of nanoparticles having a size from 1 nm to 100 nm or a nano coating having a thickness from 1 nm to 100 nm, onto a surface or surfaces of the source metal or semiconductor particulate to form a catalyst metal-coated metal or semiconductor particles, wherein the catalytic metal is different than the source metal material; and (C) exposing the catalyst metal-coated particles to a high temperature environment, from 100° C. to 2,500° C., for a period of time sufficient to enable a catalytic metal-assisted growth of multiple metal or semiconductor nanowires from the source metal particulate. Several examples are presented in a later section of the present disclosure.

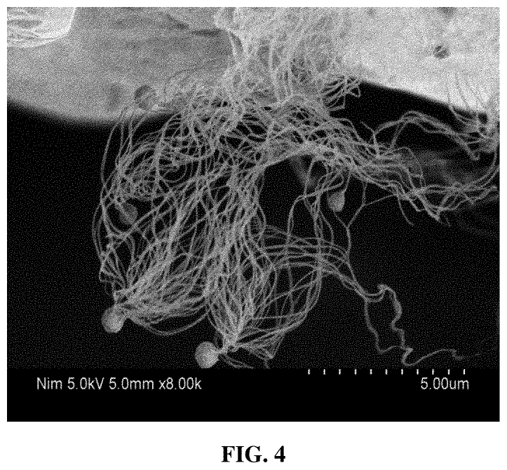

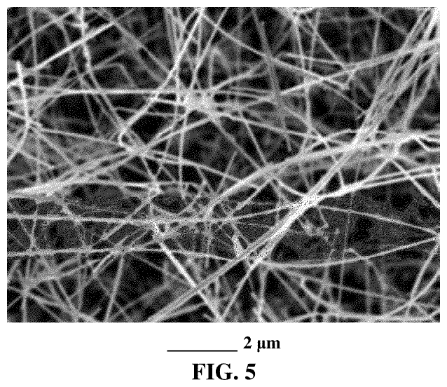

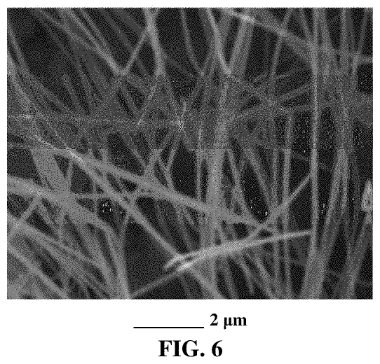

Shown in FIG. 4 is an SEM image of Si nanowires grown out of originally micron-scaled Si particles (diameter 2-3 μm in this example). FIG. 5 shows a SEM image of Ge nanowires and FIG. 6 shows a SEM image of Sn nanowires.

The disclosed composite particulates may comprise one or a plurality of nanowires of an anode active material and optional graphene sheets that are embedded in, dispersed in, or encapsulated by a conducting polymer gel network. However, preferably, the exterior surface of the composite particulate does not contain graphene sheets. The dispersed or embedded graphene sheets are preferably selected from pristine graphene, graphene oxide (GO), reduced graphene oxide (RGO), graphene fluoride, graphene chloride, graphene bromide, graphene iodide, nitrogenated graphene, hydrogenated graphene, doped graphene, chemically functionalized graphene, or a combination thereof.

Preferably, the encapsulating or embedding conducting polymer network (optionally containing a conductive additive, such as graphene sheets and carbon nanotubes, dispersed therein) has a lithium ion conductivity from 10⁻⁸ S/cm to 10⁻² S/cm (more typically from 10⁻⁵ S/cm to 10⁻³ S/cm) when measured at room temperature. The conducting network preferably has an electrical conductivity from 10⁻⁷ S/cm to 3,000 S/cm, up to 20,000 S/cm (more typically from 10⁻⁴ S/cm to 1000 S/cm) when measured at room temperature on a separate cast thin film 20 μm thick.

Preferably, the anode active material is a high-capacity anode active material having a specific lithium storage capacity greater than 372 mAh/g, which is the theoretical capacity of graphite.

Carbon materials can assume an essentially amorphous structure (glassy carbon), a highly organized crystal (graphite), or a whole range of intermediate structures that are characterized in that various proportions and sizes of graphite crystallites and defects are dispersed in an amorphous matrix. Typically, a graphite crystallite is composed of a number of graphene sheets or basal planes that are bonded together through van der Waals forces in the c-axis direction, the direction perpendicular to the basal plane. These graphite crystallites are typically micron- or nanometer-sized. The graphite crystallites are dispersed in or connected by crystal defects or an amorphous phase in a graphite particle, which can be a graphite flake, carbon/graphite fiber segment, carbon/graphite whisker, or carbon/graphite nano-fiber. In other words, graphene planes (hexagonal lattice structure of carbon atoms) constitute a significant portion of a graphite particle.

A graphene sheet or nano graphene platelet (NGP) is essentially composed of a sheet of graphene plane or multiple sheets of graphene plane stacked and bonded together (typically, on an average, less than 10 sheets per multi-layer platelet). Each graphene plane, also referred to as a graphene sheet or a hexagonal basal plane, comprises a two-dimensional hexagonal structure of carbon atoms. Each platelet has a length and a width parallel to the graphite plane and a thickness orthogonal to the graphite plane. By definition, the thickness of an NGP is 100 nanometers (nm) or smaller, with a single-sheet NGP being as thin as 0.34 nm. However, the NGPs produced with the instant methods are mostly single-layer graphene and some few-layer graphene sheets (<10 layers). The length and width of a NGP are typically between 200 nm and 20 μm, but could be longer or shorter, depending upon the sizes of source graphite material particles.

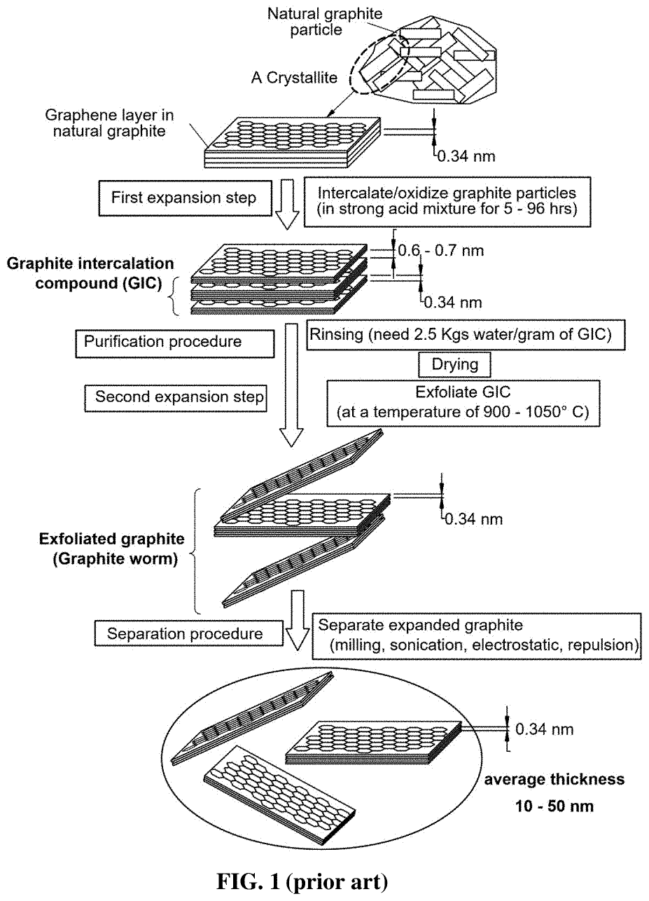

The processes for producing various types of graphene sheets are well-known in the art. As shown in FIG. 1, the chemical processes for producing graphene sheets or platelets typically involve immersing graphite powder in a mixture of concentrated sulfuric acid, nitric acid, and an oxidizer, such as potassium permanganate or sodium perchlorate, forming a reacting mass that requires typically 5-120 hours to complete the chemical intercalation/oxidation reaction. Once the reaction is completed, the slurry is subjected to repeated steps of rinsing and washing with water. The resulting suspension may be subjected to ultrasonication for yielding isolated graphene sheets.

Alternatively, the resulting suspension may be subjected to drying treatments to remove water. The dried powder, referred to as graphite intercalation compound (GIC) or graphite oxide (GO), is then subjected to a thermal shock treatment. This can be accomplished by placing GIC in a furnace pre-set at a temperature of typically 800-1100° C. (more typically 950-1050° C.). The resulting products are typically highly oxidized graphene (i.e. graphene oxide with a high oxygen content), which must be chemically or thermal reduced to obtain reduced graphene oxide (RGO). RGO is found to contain a high defect population and, hence, is not as conducting as pristine graphene. We have observed that that the pristine graphene paper (prepared by vacuum-assisted filtration of pristine graphene sheets, as herein prepared) exhibit electrical conductivity values in the range from 1,500-4,500 S/cm. In contrast, the RGO paper prepared by the same paper-making procedure typically exhibits electrical conductivity values in the range from 100-1,000 S/cm.

The preparation of conducting polymer gel network-embraced electrode active material nanowires may begin with dispersing pre-made nanowires of the anode active material and optional graphene sheets in a reactive precursor solution (e.g. a monomer, an initiator, and a curing or cross-linking agent) to form a suspension. The suspension is then dried (e.g. using spray drying) to form reactive micro-droplets comprising the reactive precursor, which is polymerized/cured, concurrently or subsequently, to obtain composite particulates. In these composite particulates, graphene sheets, if present, are included inside the micro-droplets (i.e. internal graphene sheets embedded in or encapsulated by the conducting polymer gel network).

The micro-droplets of conducting polymer network-encapsulated anode active material nanowires can contain those anode active materials capable of storing lithium ions greater than 372 mAh/g, theoretical capacity of natural graphite. Examples of these high-capacity anode active materials are Si, Ge, Sn, SnO₂, SiOₓ (0.1≤x≤1.9), Co₃O₄, etc. As discussed earlier, these materials, if implemented in the anode, have the tendency to expand and contract when the battery is charged and discharged. At the electrode level, the expansion and contraction of the anode active material can lead to expansion and contraction of the anode, causing mechanical instability of the battery cell. At the anode active material level, repeated expansion/contraction of particles of Si, Ge, Sn, SiOₓ, SnO₂, Co₃O₄, etc. quickly leads to pulverization of these particles and rapid capacity decay of the electrode. These anode active materials, when in a nanowire form, appear to exhibit no significant pulverization problem.

Furthermore, the presently disclosed composite particulates containing nanowires dispersed in a conductive polymer network typically exhibit a Coulombic efficiency higher than 99.5%, more typically higher than 99.8%, and often significantly higher than 99.9%.

Additionally, for the purpose of addressing the rapid battery capacity decay problems, the nanowires of the anode active material may contain pre-lithiated particles. In other words, before the electrode active material nanowires (such as Si, Ge, Sn, SnO₂, SiOₓ, etc.) are embedded in a conducting network polymer, they have already been previously intercalated with Li ions (e.g. via electrochemical charging).

In some embodiments, prior to the instant polymer embracing process, the nanowires of the desired anode electrode active material contain nanowires that are pre-coated with a coating of a conductive material selected from carbon, pitch, carbonized resin, a conductive polymer, a conductive organic material, a graphene coating (e.g. graphene sheets), a metal coating, a metal oxide shell, or a combination thereof. The coating layer thickness is preferably in the range from 1 nm to 10 μm, preferably from 2 nm to 1 μm, and further preferably from 5 nm to 100 nm. This coating is implemented for the purpose of establishing a stable solid-electrolyte interface (SEI) to increase the useful cycle life of a lithium-ion battery.

In some embodiments, the nanowires of solid anode active material contain nanowires that are, prior to being embedded in a conducting polymer network, pre-coated with a carbon precursor material selected from a coal tar pitch, petroleum pitch, meso-phase pitch, polymer, organic material, or a combination thereof. The method further contains a step of heat-treating the precursor to convert the carbon precursor material to a carbon material coated on active material nanowire surfaces.

In some embodiments, the method further comprises a step of exposing the composite particulates to a liquid or vapor of a conductive material that is conductive to electrons and/or ions of lithium, sodium, magnesium, aluminum, or zinc. This procedure serves to provide a stable SEI or to make the SEI more stable.

Several micro-encapsulation processes require the conductive polymer to be dissolvable in a solvent or its precursor (or monomer or oligomer prior) initially contains a liquid state (flowable). Fortunately, all the polymers used herein are soluble in some common solvents or the monomer or other polymerizing/curing ingredients themselves are in a liquid state to begin with. This solution can then be used to provide a mixture of anode active material nanowires and a reacting polymer (along with an optional conductive materials, such as graphene sheets, CNTs, and CNFs) to form into composite particles via several of the micro-encapsulation methods discussed in what follows.

There are three broad categories of micro-encapsulation methods that can be implemented to produce conducting polymer network embedded or encapsulated anode particles (the micro-droplets): physical methods, physico-chemical methods, and chemical methods. The physical methods include pan-coating, air-suspension coating, centrifugal extrusion, vibration nozzle, and spray-drying methods. The physico-chemical methods include ionotropic gelation and coacervation-phase separation methods. The chemical methods include interfacial polycondensation, interfacial cross-linking, in-situ polymerization, and matrix polymerization.

Pan-coating method: The pan coating process involves tumbling the anode active material nanowires in a pan or a similar device while the matrix or encapsulating material (e.g. monomer/oligomer liquid or polymer/solvent solution) is applied slowly until multiple particulates containing nanowires dispersed in a conductive polymer network are obtained.

Air-suspension coating method: In the air suspension coating process, the nanowires of anode active material are dispersed into the supporting air stream in an encapsulating chamber. A controlled stream of a polymer-solvent solution (e.g. polymer or its monomer or oligomer dissolved in a solvent; or its monomer or oligomer alone in a liquid state) is concurrently introduced into this chamber, allowing the solution to hit and coat the suspended nanowires. These suspended nanowires are encapsulated (fully coated) with or dispersed in a polymer or reactive precursor (monomer, oligomer, etc. which is polymerized/cured concurrently or subsequently) while the volatile solvent is removed. This process may be repeated several times until the required parameters, such as full-coating thickness (i.e. encapsulating shell or wall thickness), are achieved. The air stream which supports the anode particles also helps to dry them, and the rate of drying is directly proportional to the temperature of the air stream, which can be adjusted for optimized shell thickness.

In a preferred mode, the nanowires in the encapsulating zone portion may be subjected to re-circulation for repeated coating. Preferably, the encapsulating chamber is arranged such that the nanowires pass upwards through the encapsulating zone, then are dispersed into slower moving air and sink back to the base of the encapsulating chamber, enabling repeated passes of the nanowires through the encapsulating zone until the desired encapsulating shell thickness is achieved.

Centrifugal extrusion: Nanowires may be encapsulated with a polymer or precursor material using a rotating extrusion head containing concentric nozzles. In this process, a stream of core fluid (slurry containing anode nanowires dispersed in a solvent) is surrounded by a sheath of shell solution or melt containing the polymer or precursor. As the device rotates and the stream moves through the air it breaks, due to Rayleigh instability, into droplets of core, each coated with the shell solution. While the droplets are in flight, the molten shell may be hardened or the solvent may be evaporated from the shell solution. If needed, the capsules can be hardened after formation by catching them in a hardening bath. Since the drops are formed by the breakup of a liquid stream, the process is only suitable for liquid or slurry. A high production rate can be achieved. Up to 22.5 kg of microcapsules can be produced per nozzle per hour and extrusion heads containing 16 nozzles are readily available.

Vibrational nozzle encapsulation method: Core-shell encapsulation or matrix-encapsulation of anode nanowires can be conducted using a laminar flow through a nozzle and vibration of the nozzle or the liquid. The vibration has to be done in resonance with the Rayleigh instability, leading to very uniform droplets. The liquid can consist of any liquids with limited viscosities (1-50,000 mPa·s): emulsions, suspensions or slurry containing the anode active material nanowires and the polymer or precursor. The solidification can be done according to the used gelation system with an internal gelation.

Spray-drying: Spray drying may be used to encapsulate anode nanowires when the nanowires are suspended in a melt or polymer/precursor solution to form a suspension. In spray drying, the liquid feed (solution or suspension) is atomized to form droplets which, upon contacts with hot gas, allow solvent to get vaporized and thin polymer shell or matrix to fully embrace the nanowires. If pre-made graphene sheets are included in the suspension, the micro-droplets formed may contain graphene sheets in the matrix of the composite particulates.

Coacervation-phase separation: This process consists of three steps carried out under continuous agitation:
(a) Formation of three immiscible chemical phases: liquid manufacturing vehicle phase, core material phase and encapsulation material phase. The anode nanowires are dispersed in a solution of the encapsulating polymer or precursor. The encapsulating material phase, which is an immiscible polymer in liquid state, is formed by (i) changing temperature in polymer solution, (ii) addition of salt, (iii) addition of non-solvent, or (iv) addition of an incompatible polymer in the polymer solution.
(b) Deposition of encapsulation shell material: anode nanowires being dispersed in the encapsulating polymer solution, encapsulating polymer/precursor coated around anode nanowires, and deposition of liquid polymer embracing around anode nanowires by polymer adsorbed at the interface formed between core material and vehicle phase; and
(c) Hardening of encapsulating shell material: shell material being immiscible in vehicle phase and made rigid via thermal, cross-linking, or dissolution techniques.

In-situ polymerization: In some micro-encapsulation processes, anode nanowires are fully coated with a monomer or oligomer first. Then, direct polymerization of the monomer or oligomer is carried out on the surfaces of these nanowires.

Matrix polymerization: This method involves dispersing and embedding anode nanowires in a polymeric matrix during formation of the particulates. This can be accomplished via spray-drying, in which the particulates are formed by evaporation of the solvent from the matrix material. Another possible route is the notion that the solidification of the matrix is caused by a chemical change.

The following examples serve to provide the best modes of practice for the present disclosure and should not be construed as limiting the scope of the disclosure:

### Example 1: Production of PEDOT:PSS-Embedded Anode Nanowires

Several types of anode active materials in a nanowire form were investigated. These include Si, Ge, and SiOₓ (0<x<2), etc., which are used as examples to illustrate the best mode of practice. These active material nanowires were prepared in house according to procedures described earlier and also some samples given below.

Poly(3,4-ethylenedioxythiophene):polystyrene sulfonate (PEDOT:PSS) is a polymer mixture of two ionomers. One component is made up of sodium polystyrene sulfonate, which is sulfonated polystyrene. Part of the sulfonyl groups are deprotonated and carry a negative charge. The other component poly(3,4-ethylenedioxythiophene) or PEDOT is a conjugated polymer, polythiophene, which carries positive charges. Together the two charged polymers form a macromolecular salt. The PEDOT/PSS is initially soluble in water. If a curing agent is used, the polymer may be further cured to increase the degree of cross-linking.

Nanowires of an anode active material were dispersed in a PEDOT/PSS-water solution to form a slurry (2-8% by wt. solid content), which was spray-dried to form micro-droplets of PEDOT/PSS-embedded anode active material nanowires.

### Example 2: Composite Particulates Containing Sn, Si, and Ge Nanowires Embedded in Polypyrrole (PPy) Gel Network

The process of example 1 was replicated with PEDOT/PSS being replaced by polypyrrole (PPy) network. The polypyrrole hydrogel was prepared by following the following procedure: Solution A was prepared by mixing 1 mL H₂O and 0.5 mL phytic acid together and then injecting 142 μL pyrrole into the solution, which was sonicated for 1 min. Solution B was prepared by dissolving 0.114 g ammonium persulfate in 0.5 mL H₂O. The solution A and B were separately cooled to 4° C. and then solution B was added into solution A quickly to form a reacting precursor solution.

The Sn, SiOₓ, and Ge nanowires were separately dispersed in a reacting precursor solution, along with optional graphene sheets, to form a suspension, which was rapidly spray-dried to form micro-droplets. These micro-droplets contain both anode active material nanowires and optional graphene sheets embedded in polypyrrole hydrogel. The micro-droplets were partially or totally dried by removing portion or all of the water content from the gel under vacuum at 60° C. to form composite particulates comprising nanowires dispersed in the conductive polymer network.

### Example 3: Production of Polyaniline Gel Network-Encapsulated Nanowires

The precursor may contain a monomer, an initiator or catalyst, a crosslinking or gelating agent, an oxidizer and/or dopant. As an example, 3.6 ml aqueous solution A, which contains 400 mM aniline monomer and 120 mM phytic acid, was added and mixed with 280 mg Si nanowires. Subsequently, 1.2 ml solution B, containing 500 mM ammonium persulfate, was added into the above mixture and subjected to bath sonication for 1 min. The mixture suspension was spray-dried to form micro-droplets. In about 5 min, the solution changed color from brown to dark green and became viscous and gel-like, indicating in-situ polymerization of aniline monomer to form the PANi hydrogel. The micro-droplets were then vacuum-dried at 50° C. for 24 hours to obtain PANi network polymer-encapsulated Si nanowires.

The resulting composite particulates, along with a SBR binder, and Super-P conductive additive were then made into an anode electrode.

### Examples 4: Heparin-Based Material as a Curing Agent for the Preparation of a Conducting Polymer Network

The encapsulating conducting polymer may be produced from a monomer using heparin-based crosslinking or gelating agent (e.g. in addition to phytic acid). Aqueous solutions of heparin (0.210% w/w) were prepared using 5M NaOH. Photo-cross-linkable heparin methacrylate (Hep-MA) precursors were prepared by combining heparin (porcine source, Mw˜1719 kDa) incubated with methacrylic anhydride (MA) and adjusted to pH=8. The degree of substitution (DS) of methacrylate groups covalently linked to heparin precursors was measured by 1H nuclear magnetic resonance. The DS was determined from integral ratios of peaks of the methacrylate groups at 6.2 ppm compared to peak corresponding to methyl groups in heparin at 2.05 ppm.

Solutions used for photopolymerization were incubated with 2-methyl-1-[4-(hydeoxyethoxy)phenyl]-2-methyl-1-propanone (Irgacure 2959) to create final concentrations of 0.5% (w/w) of photoinitiator. Gels were photo-cross-linked using UV illumination for 30-60 min (λmax=365 nm, 10 mW/cm²). Hep-MA/PANI dual-networks were formed by sequentially incubating cross-linked Hep-MA hydrogels in aqueous solutions of ANI ([ANI]₀, between 0.1 and 2 M, 10 min) and acidic solutions of APS ([APS]₀, between 12.5 mM and 2 M, 20120 min). The gel fraction of Hep-MA/PANI dual networks was recovered by washing in di H₂O after oxidative polymerization. Nanowires of a desired anode active material could be added into the reacting mass during various stages of reactions, but preferably added right before photopolymerization.

### Example 5: Zinc-Assisted Growth of Sn Nanowires from Sn Particles

Tin particles were coated with a thin layer of Zn using a simple physical vapor deposition up to a thickness of 1.1-3.5 nm. The Sn—Zn system is known to have a eutectic point at Te=198.5° C. and Ce=85.1% Sn. A powder mass of Zn-coated Sn particles (3.5 μm in diameter) were heated to 220° C. and allowed to stay at 220° C. for 1 hour and then cooled down to 200° C. and maintained at 200° C. for 30 minutes. The material system was then naturally cooled to room temperature after switching off the power to the oven. The Sn nanowires grown from Sn particles were found to have diameters in the approximate range of 25-65 nm.

### Example 6: Gold-Assisted Growth of Ge Nanowires from Ge Particles

Ge particles (platelets of 1.2 μm long and 0.25 μm thick) were coated with a thin layer of Au using sputtering deposition up to a thickness of 1.5-5.6 nm. The Ge—Au system is known to have a eutectic point at Te=361° C. and Ce=28% Ge. A powder mass of Au-coated Ge particles were heated to 600° C. and allowed to stay at 600° C. for 2 hours and then cooled down to 370° C. and maintained at 370° C. for 1 hour. The material system was then cooled to 355° C. for 2 hours and then naturally cooled to room temperature after switching off the power to the oven.

Gold catalyst-assisted growth of Ge nanowires from Ge particles occurred during the subsequent cooling process. The diameter of Ge nanowires produced is in the range from 42 nm to 67 nm.

### Example 7: Copper-Assisted Growth of Sb Nanowires from Sb Particles

The work began with the preparation of antimony (Sb) particles, which entailed mixing Sb₂O₃ particles with small activated carbon (AC) particles using ball milling. By heating the resulting mixture in a sealed autoclave and heating the mixture to 950° C., antimony was obtained from the oxide by a carbothermal reduction: 2 Sb₂O₃+3 C→4 Sb+3 CO₂. The Sb particles produced typically resided in pores of AC, which could be recovered by breaking up the AC particles with ball-milling.

The Sb particles were immersed in a solution of copper acetate in water. Water was subsequently removed and the dried particles were coated with a thin layer of copper acetate. These metal precursor-coated Sb particles were then exposed to a heat treatment in a reducing atmosphere of H₂ and Ar gas according to a desired temperature profile. This profile typically included from room temperature to a reduction temperature of approximately 300-600° C. (for reduction of copper acetate to Cu nano coating). The temperature was continued to rise to a final temperature of 526-620° C. for 1-3 hours. The system was allowed to cool down to 520° C. for 1 hour and then cooled down naturally to room temperature, resulting in copper metal catalyst-assisted growth of Sb nanowires from Sb particles.

### Example 8: Lithium-Ion Batteries Featuring Ge and Sn Nanowires as an Anode Active Material

For electrochemical testing, several types of anodes and cathodes were prepared. For instance, a layer-type of anode was prepared by simply coating slurry of composite particulates containing Si, Ge or Sn nanowires dispersed in a conductive network polymer, conductive additives, and a binder resin to form an anode layer against a sheet of Cu foil (as an anode current collector).

For instance, the working electrodes were prepared by mixing 75 wt. % active material (composite particulates), 17 wt. % acetylene black (Super-P, as a conductive additive), and 8 wt. % polyvinylidene fluoride (PVDF) as a binder dissolved in N-methyl-2-pyrrolidinoe (NMP). After coating the slurries on Cu foil, the electrodes were dried at 120° C. in vacuum for 2 h to remove the solvent before a compression treatment.

Then, the electrodes were cut into a disk (ϕ=12 mm) and dried at 100° C. for 24 h in vacuum. Electrochemical measurements were carried out using CR2032 (3V) coin-type cells with lithium metal as the counter/reference electrode, Celgard 2400 membrane as separator, and 1 M LiPF₆ electrolyte solution dissolved in a mixture of ethylene carbonate (EC) and diethyl carbonate (DEC) (EC-DEC, 1:1 v/v). Various anode material compositions were evaluated. The cell assembly was performed in an argon-filled glove-box. The CV measurements were carried out using a CH-6 electrochemical workstation at a scanning rate of 1 mV/s. The electrochemical performance of Si nanowires was also evaluated by galvanostatic charge/discharge cycling at a current density of 50-1,000 mA/g, using a LAND electrochemical workstation. Full-cell pouch configurations using lithium iron phosphate and lithium cobalt oxide cathodes were also prepared and tested.

It may be noted that the lithium-ion battery industry has adopted a nomenclature system for a charge or discharge rate. For instance, 1° C. charging means completing charging procedure in 1 hour and 2° C. charging means completing charging procedure in ½ hours (30 minute). A 10° C. charging rate means charging completion in 1/10 hours (6 minutes).

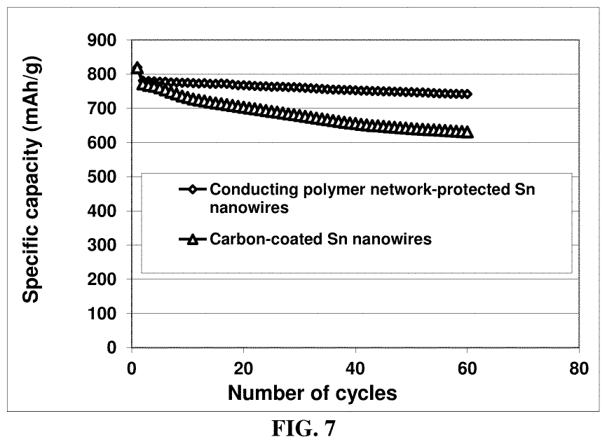

Some experimental results are summarized in FIG. 7, which indicates that the composite anode containing 75% by wt. of composite particulates (prepared in Example 2) Sn nanowires (prepared in Example 5), having a diameter of 45 nm, dispersed in polypyrrole network polymer is capable of delivering a significantly more stable cycling behavior as compared to the conventional carbon-coated counterpart.

In the lithium-ion battery industry, it is a common practice to define the cycle life of a battery as the number of charge-discharge cycles that the battery suffers 20% decay in capacity based on the initial capacity measured after the required electrochemical formation. We have observed that, in general, the strategy of embedding nanowires (all anode nanowires investigated) in a conducting polymer network lead to a significantly higher cycle life of a lithium-ion battery.

1. A composite particulate for use in a lithium-ion battery anode, said composite particulate comprising one or a plurality of nanowires of an anode active material, having a diameter or thickness from 0.5 nm to 500 nm, encapsulated by or embedded in an electrically and/or ionically conducting polymer gel network.

2. The composite particulate of claim 1, further comprising graphene sheets that are embedded in said conducting polymer gel network.

3. The composite particulate of claim 1, wherein said electrically conducting polymer gel network comprises a conjugated polymer selected from polyacetylene, polythiophene, poly(3-alkylthiophenes), polypyrrole, polyaniline, poly(isothianaphthene), poly(3,4-ethylenedioxythiophene), alkoxy-substituted poly(p-phenylene vinylene), poly(2,5-bis(cholestanoxy) phenylene vinylene), poly(p-phenylene vinylene), poly(2,5-dialkoxy) paraphenylene vinylene, poly[(1,4-phenylene-1,2-diphenylvinylene)], poly(3′,7′-dimethyloctyloxy phenylene vinylene), polyparaphenylene, polyparaphenylene, polyparaphenylene sulphide, polyheptadiyne, poly(3-hexylthiophene), poly(3-octylthiophene), poly(3-cyclohexylthiophene), poly(3-methyl-4-cyclohexylthiophene), poly(2,5-dialkoxy-1,4-phenyleneethynylene), poly(2-decyloxy-1,4-phenylene), poly(9,9-dioctylfluorene), polyquinoline, a derivative thereof, a copolymer thereof, a sulfonated version thereof, or a combination thereof.

4. The composite particulate of claim 1, wherein said electrically conducting polymer gel network comprises a polyaniline hydrogel, polypyrrole hydrogel, or polythiophene hydrogel in a dehydrated state.

5. The composite particulate of claim 1, wherein said ionically conducting polymer gel network comprises a polymer selected from poly(ethylene oxide), polypropylene oxide, poly(ethylene glycol), poly(acrylonitrile), poly(methyl methacrylate), poly(vinylidene fluoride), poly bis-methoxy ethoxyethoxide-phosphazene, polyvinyl chloride, polydimethylsiloxane, poly(vinylidene fluoride)-hexafluoropropylene, cyanoethyl poly(vinyl alcohol), a pentaerythritol tetraacrylate-based polymer, an aliphatic polycarbonate, a single Li-ion conducting solid polymer electrolyte with a carboxylate anion, a sulfonylimide anion, or sulfonate anion, a crosslinked electrolyte of poly(ethylene glycol) diacrylate or poly(ethylene glycol) methyl ether acrylate, a sulfonated derivative thereof, or a combination thereof.

6. The composite particulate of claim 2, wherein said graphene sheets are selected from pristine graphene, graphene oxide, reduced graphene oxide, graphene fluoride, graphene chloride, graphene bromide, graphene iodide, nitrogenated graphene, hydrogenated graphene, doped graphene, chemically functionalized graphene, or a combination thereof.

7. The composite particulate of claim 1, wherein said electrically or ionically conducting polymer gel network is reinforced with a high-strength material selected from carbon nanotubes, carbon nano-fibers, carbon or graphite fibers, graphene sheets, expanded graphite flakes, polymer fibrils, glass fibers, ceramic fibers, metal filaments or metal nano-wires, whiskers, or a combination thereof.

8. The composite particulate of claim 1, wherein said anode active material is selected from the group consisting of: (a) silicon (Si), germanium (Ge), tin (Sn), lead (Pb), antimony (Sb), bismuth (Bi), zinc (Zn), aluminum (Al), titanium (Ti), nickel (Ni), cobalt (Co), and cadmium (Cd); (b) oxides of Si, Ge, Sn, Pb, Sb, Bi, Zn, Al, Ti, Fe, Ni, Co, V, and Cd; (c) prelithiated versions thereof; and (d) combinations thereof.

9. The composite particulate of claim 1, wherein said anode active material contains a prelithiated Si, prelithiated Ge, prelithiated Sn, prelithiated SnOₓ, prelithiated SiO_{y}, or a combination thereof, wherein 0.1≤x≤2 and 0.1≤y≤1.9.

10. The composite particulate of claim 1, wherein at least one of said nanowires is coated with a layer of carbon, graphite, or graphene.

11. The composite particulate of claim 1, wherein said particulate further comprises from 0.1% to 40% by weight of a lithium ion-conducting additive dispersed in said electrically or ionically conducting polymer gel network.

12. The composite particulate of claim 11, wherein said lithium ion-conducting additive is selected from Li₂CO₃, Li₂O, Li₂C₂O₄, LiOH, LiX, ROCO₂Li, HCOLi, ROLi, (ROCO₂Li)₂, (CH₂OCO₂Li)₂, Li₂S, LiₓSO_{y}, or a combination thereof, wherein X=F, Cl, I, or Br, R=a hydrocarbon group, 0≤x≤1, 1≤y≤4.

13. The composite particulate of claim 11, wherein said lithium ion-conducting additive contains a lithium salt selected from lithium perchlorate (LiClO4), lithium hexafluorophosphate (LiPF6), lithium borofluoride (LiBF4), lithium hexafluoroarsenide (LiAsF6), lithium trifluoro-methanesulfonate (LiCF3SO3), bis-trifluoromethyl sulfonylimide lithium (LiN(CF3SO2)2), lithium bis(oxalato)borate (LiBOB), lithium oxalyldifluoroborate (LiBF2C2O4), lithium nitrate (LiNO3), Li-fluoroalkyl-phosphate (LiPF3(CF2CF3)3), lithium bisperfluoro-ethylsulfonylimide (LiBETI), lithium bis(trifluoromethanesulfonyl)imide, lithium bis(fluorosulfonyl)imide, lithium trifluoromethanesulfonimide (LiTFSI), an ionic liquid-based lithium salt, or a combination thereof.

14. A powder mass comprising the composite particulate of claim 1.

15. A battery anode containing the composite particulate of claim 1.

16. A process of producing multiple composite particulates of claim 1, the process comprises (A) dispersing multiple nanowires of the desired anode active material in a reacting mass comprising an oligomer or a monomer, an initiator or catalyst, and a curing or cross-linking agent to form a reacting slurry; (B) forming the reacting slurry into multiple reacting droplets, wherein the droplet comprises one or a plurality of nanowires of an anode active material dispersed in a matrix of polymerizing or cross-linking chains; and (C) converting the polymerizing or cross-linking chains into a network polymer in the droplets to form the composite particulates.

17. The process of claim 16, wherein Step (B) of forming reacting droplets comprises operating a procedure selected from pan-coating, air-suspension coating, centrifugal extrusion, vibration-nozzle encapsulation, spray-drying, coacervation-phase separation, interfacial polycondensation or interfacial cross-linking, in-situ polymerization, matrix polymerization, or a combination thereof.
